(19) United States
(12) Patent Application Publication
(10) Pub. No.: US 2010/0081751 A1
(43) Pub. Date: Apr. 1, 2010

(54) Use of an Organopolysiloxane Composition Vulcanizable From Room Temperature To Form A Self-Adhesive Elastomer

(75) Inventors: Delphine Blanc-Magnard, Lyon (FR); Georges Barrandon, Mornant (FR)

Correspondence Address: Baker Donelson Bearman, Caldwell & Berkowitz, PC, 555 Eleventh Street, NW, Sixth Floor, Washington, DC, 20004, US

(73) Assignee: Bluestar Silicones France, F-69486 Lyon Cedex 03 (FR)

(21) Appl. No.: 11/993,732

(22) PCT Filed: Jun. 14, 2006
(86) PCT No.: PCT/FR06/01342

§ 371 Date: Aug. 3, 2009

(30) Foreign Application Priority Data
Jun. 24, 2005 (FR) 0506435

(51) Int. Cl. C08L 83/04

(52) U.S. Cl. 524/500; 524/588

(57) ABSTRACT

An organopolysiloxane composition and precursors thereof are provided herein. The invention also relates to methods for manufacture and use of a organopolysiloxane composition to prepare a silicone elastomer which can be used, for example, as a seal and/or adhesive.

The present invention relates to the use of an organopolysiloxane composition, presented before use in a two-component form (RTV-2), vulcanizable from room temperature to give a self-adhesive elastomer on most varied supports, in particular on glass, metals, wood, polycarbonates and plastics, such as polyvinyl chloride (PVC), this being the case even in an enclosed atmosphere and after a heat treatment. More particularly, the present invention is targeted at compositions presented before use in the form of two components (RTV-2 compositions).

Organopolysiloxane compositions vulcanizable from room temperature are well known and are classified into two distinct groups: one-component (RTV-1) compositions and two-component (RTV-2) compositions.

Generally, one-component compositions crosslink when they are exposed to atmospheric moisture, that is to say that they cannot crosslink in an enclosed medium. One solution to this problem is described in French patent application FR-2 603 894, which describes an organopolysiloxane composition which cures to give an elastomer even in an enclosed atmosphere carrying acyloxy radicals bonded to silicon atoms and including a curing accelerator added before use chosen from the following hydroxides or oxides: CaO, SrO and BaO. However, these accelerated curing RTV-1 compositions which can crosslink under enclosed conditions exhibit the disadvantage of showing mediocre adhesion to the various substrates, such as metals, wood, plastics, concrete, and the like.

One solution which is currently used to overcome the problem of adhesion consists in employing a phase in which a primer is applied to the support before carrying out the deposition of the RTV-1 composition. Normal primers are, for example, a mixture of alkoxysilanes and of resin in organic solution. As the stage in which a primer is applied is rather expensive, a system which makes it possible to dispense with it is of great interest.

With regard to the two-component compositions, they are sold and stored in the form of two components, a first component comprising the base polymeric materials and the second component comprising the catalyst. The two components are mixed during use and the mixture crosslinks in the form of a relatively hard elastomer.

These two-component compositions are well known and are described in particular in the work by Walter Noll, “Chemistry and Technology of Silicones”, 1968, 2^{nd} edition, on pages 395 to 398.

These compositions essentially comprise four different ingredients:
a reactive α,ω-dihydroxydiorganopolysiloxane polymer,
a crosslinking agent, generally a silicate or a polysilicate,
a tin catalyst, and
water.

The mechanical properties of these compositions are then adjusted by the addition of fillers.

Two-component organopolysiloxane compositions which self-adhere by incorporation in a composition of silanes comprising an amine functional group are described in U.S. Pat. No. 3,801,572 and U.S. Pat. No. 3,888,815.

However, this patent does not set out the problem, nor provide a solution, of supplying self-adhesive seals and/or adhesives which retain, after a heat treatment, the following properties:
1) noteworthy adhesion to the most varied substrates and in particular to glass, metals, in particular aluminum, and plastics, in particular PVC,
2) good mechanical properties after crosslinking, this being the case even after a long-lasting heat treatment, and
3) good resistance to “reversion”. This is because, when these elastomers are subjected to heating after crosslinking, there very often occurs a phenomenon which is denoted by experts under the name of “reversion”. During this heating, the elastomers liquefy, in particular at the core. This “reversion” may already occur at temperatures of greater than 80° C. However, in the majority of cases, it occurs at temperatures of greater than 100° C. and it is particularly marked when the heating of the elastomers is carried out in the complete or virtually complete absence of air, that is to say when, during the heating, the elastomers are found in a completely enclosed system. This “reversion” thus constitutes a disadvantage which is a great nuisance, in particular for certain applications where the cured elastomers are heated after crosslinking.

Moreover, the pot life, that is to say the time during which the composition can be used after mixing without curing, has to be sufficiently long, in order to allow it to be used, but sufficiently short, in order to obtain a molded item which can be handled at the latest a few minutes after it has been manufactured. It is therefore desirable that the catalyst makes it possible to obtain a good compromise between the pot life of the catalyzed mixture and the time at the end of which the molded item can be handled. In addition, the catalyst must confer, on the catalyzed mixture:
1) a spreading time which does not vary according to the storage time;
2) a rapid rate of setting at room temperature (at the surface and under enclosed conditions) while retaining a sufficiently long pot life (of the order of a few minutes) to allow it to be used; and
3) good extrudability.

There has now been found, and it is this which constitutes the subject matter of the present invention, a novel polycondensation RTV-2 composition which makes it possible to obtain, after mixing of the two components and crosslinking, an excellent compromise with regard to setting kinetics and adhesive properties, even after a long-lasting heat treatment, or obtaining good resistance to “thermal reversion”.

More specifically, the present invention relates to the use of an organopolysiloxane composition vulcanizable to give a silicone elastomer from room temperature by polycondensation reactions in the preparation of self-adhesive seals and/or adhesives which retain good adhesion after a heat treatment at a temperature ≧100° C. for 3 days:
a breaking stress ≧1.2 MPa and
a cohesive failure facies ≧70%.

The said organopolysiloxane composition comprising:
a) a silicone base capable of curing to give a silicone elastomer in the presence of a catalyst by polycondensation reactions comprising:
   per 100 parts by weight of at least one reactive α,ω-dihydroxydiorganopolysiloxane polymer (A),
   from 0.1 to 60 parts by weight of at least one crosslinking agent (B), and
   from 0.001 to 10 parts by weight of water, and
b) a catalytically effective amount of a polycondensation catalytic system (D),
   said composition being characterized in that the catalytic system (D) consists of a mixture of a tin-silicon compound (D1) and of at least one aminated polyalkoxysilane compound (D3), said compounds corresponding to the following definitions:
   the tin-silicon compound (D1) is the product of the reaction of at least one organoalkoxysilane corresponding to the following general formula (I):

R⁰ₐSi(OR¹)₄₋ₐ (I)

with at least one dialkyltin salt corresponding to the following general formula (II):

R²R³Sn(OCOR⁴)₂ (II)
in which formulae:
   the R⁰ substituents represent: a saturated or unsaturated, linear or branched, aliphatic hydrocarbon group, a saturated or unsaturated and/or aromatic, monocyclic or polycyclic, carbocyclic group,
   the R¹ substituents, which are identical or different, represent a saturated or unsaturated aliphatic hydrocarbon group; R¹ can additionally mean an ROR′¹ radical in which R is a divalent hydrocarbon radical having up to 6 carbon atoms and R′¹ represents a saturated or unsaturated aliphatic hydrocarbon group;
   a=0, 1, 2 or 3;
   the R², R³ and R⁴ substituents represent, each independently of one another, a saturated or unsaturated, linear or branched, aliphatic hydrocarbon group, a saturated or unsaturated and/or aromatic, monocyclic or polycyclic, carbocyclic group; and
   the aminated polyalkoxysilane compound (D3) has the general formula:

(R⁵)_{b}(R⁶)_{c}Si(OR⁷)_{4-(b+c)} (III)
in which formula:
   b=0 or 1;
   c=1;
   R⁵ represents a saturated or unsaturated, linear or branched, aliphatic hydrocarbon group, a saturated or unsaturated and/or aromatic, monocyclic or polycyclic, carbocyclic group,
   R⁷ each represent, independently of one another, a saturated or unsaturated aliphatic hydrocarbon group;
   R⁶ represents a functional group of formula:

—Z—(X)ₙ
with:
   n=1 or 2;
   Z represents a divalent radical derived from a group chosen from: a saturated or unsaturated aliphatic hydrocarbon group, a saturated, unsaturated and/or aromatic, monocyclic or polycyclic, carbocyclic group; said divalent radical optionally being substituted or interrupted by at least one oxygen atom and/or at least one nitrogen atom;
   X represents:
   an —NR⁸R⁹ residue where the R⁸ and R⁹ substituents, which are identical or different, each represent a hydrogen atom, a saturated or unsaturated, linear or branched, aliphatic hydrocarbon group, optionally substituted by an amino group, a saturated or unsaturated and/or aromatic, monocyclic or polycyclic, carbocyclic group, it being possible for the R⁸ and R⁹ substituents optionally in addition to form, together and with the nitrogen atom to which they are bonded, a ring comprising, in the ring, 3 to 6 carbon atoms and one or two nitrogen atom(s); or
   an —R¹⁰—NH₂ radical where the R¹⁰ symbol represents a divalent radical derived from a group chosen from: a saturated or unsaturated aliphatic hydrocarbon group, a saturated, unsaturated and/or aromatic, monocyclic or polycyclic, carbocyclic group and a group exhibiting a saturated or unsaturated aliphatic hydrocarbon part and a saturated, unsaturated and/or aromatic, monocyclic or polycyclic, carbocyclic part; said divalent radical optionally being substituted or interrupted by at least one oxygen atom and/or at least one nitrogen atom;
      it being possible for said aminated polyalkoxysilane (D3) optionally to be provided in the form of a hydrolysis condensation product derived from the formula (III).

According to one embodiment of the invention, the tin/silicon compound (D1) is prepared according to the following stages:
a) at least one organoalkoxysilane (I) as claimed in claim 1 is reacted, at a temperature ≧80° C., preferably of between 95° C. and 140° C., with at least one dialkyltin salt (II) as claimed in claim 1, and
b) the resulting product is isolated.

In the above, the term “aliphatic hydrocarbon group” is understood to mean a linear or branched group, preferably comprising from 1 to 25 carbon atoms, which is optionally substituted.

Advantageously, said aliphatic hydrocarbon group comprises from 1 to 18 carbon atoms, better still from 1 to 8 carbon atoms and even better still from 1 to 6 carbon atoms.

Mention may be made, as saturated aliphatic hydrocarbon group, of alkyl groups, such as the methyl, ethyl, propyl, isopropyl, n-butyl, isobutyl, tert-butyl, pentyl, isopentyl, neopentyl, 2-methylbutyl, 1-ethylpropyl, hexyl, isohexyl, neohexyl, 1-methylpentyl 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl, 7,7-dimethyloctyl and hexadecyl radicals.

The unsaturated aliphatic hydrocarbon groups comprise one or more unsaturations, preferably one, two or three unsaturations of ethylenic type (double bond) and/or acetylenic type (triple bond).

Examples thereof are the alkenyl or alkynyl groups deriving from the alkyl groups defined above by elimination of two or more hydrogen atoms. Preferably, the unsaturated aliphatic hydrocarbon groups comprise a single unsaturation.

In the context of the invention, the term “carbocyclic group” is understood to mean an optionally substituted, preferably C₃-C₅₀, monocyclic or polycyclic radical. Advantageously, it is a C₃-C₁₈ radical which is preferably mono-, bi- or tricyclic. When the carbocyclic group comprises more than one cyclic nucleus (case of polycyclic carbocycles), the cyclic nuclei are fused in pairs. Two fused nuclei can be ortho-fused or peri-fused.

The carbocyclic group can comprise, unless otherwise indicated, a saturated part and/or an aromatic part and/or an unsaturated part.

Examples of saturated carbocyclic groups are cycloalkyl groups. Preferably, the cycloalkyl groups are C₃-C₁₈, better still C₅-C₁₀, cycloalkyl groups. Mention may in particular be made of the cyclopentyl, cyclohexyl, cycloheptyl, cyclooctyl, adamantyl or norbornyl radicals.

The unsaturated carbocycle or any unsaturated part of carbocyclic type exhibits one or more ethylenic unsaturations, preferably one, two or three. It advantageously exhibits from 6 to 50 carbon atoms, better still from 6 to 20 carbon atoms, for example from 6 to 18 carbon atoms. Examples of unsaturated carbocycles are C₆-C₁₀ cycloalkenyl groups.

Examples of aromatic carbocyclic radicals are (C₆-C₁₈) aryl groups, better still (C₆-C₁₂) aryl groups, and in particular phenyl, naphthyl, anthryl and phenanthryl.

A group exhibiting both an aliphatic hydrocarbon part as defined above and a carbocyclic part as defined above is, for example, an arylalkyl group, such as benzyl, or an alkylaryl group, such as tolyl.

The substituents of the aliphatic hydrocarbon groups or parts and of the carbocyclic groups or parts are, for example, alkoxy groups in which the alkyl part is preferably as defined above.

According to a particularly advantageous form, the substituents of the organoalkoxysilane of formula (I) and of the dialkyltin salt of formula (II) are defined in the following way:
R⁰ represents a linear or branched C₁-C₈ alkyl radical, a C₅-C₁₀ cycloalkyl radical or a C₆-C₁₈ aryl radical; preferably a methyl, ethyl, propyl, isopropyl, n-butyl, t-butyl, cyclohexyl or phenyl radical;
R¹ represents a linear or branched C₁-C₈ alkyl radical; preferably, a methyl, ethyl, propyl, isopropyl, n-butyl or t-butyl radical and more preferably still a methyl or ethyl radical,
R² and R³, which are identical or different, each represent a linear or branched C₁-C₈ alkyl radical, a C₅-C₁₀ cycloalkyl radical or a C₆-C₁₈ aryl radical; preferably, a linear or branched C₁-C₈ alkyl radical, and
R⁴ represents a linear or branched C₁-C₃₀ alkyl radical, preferably a linear C₁-C₂₀ alkyl radical and more preferably still a methyl radical or an undecyl (C₁₁) radical.

The organoalkoxysilanes of formula (I) are well known compounds described in particular in French patents FR-1 330 625, FR-2 121 289, FR-2 121 631, FR-2 458 572 and FR-2 592 657 cited as reference.

Use may be made, for example, of the silanes of formula:

CH₃Si(OCH₃)₃

CH₃Si(OCH₂CH₃)₃

CH₃Si(OCH₂CH₂OCH₃)₃

Si(OCH₂CH₂OCH₃)₄

Si(OCH₃)₄

Si(OCH₂CH₃)₄

CH₂═CH—Si(OCH₂CH₂OCH₃)₃

C₆H₅Si(OCH₃)₃

C₆H₅Si(OCH₂CH₂OCH₃)₃

CH₃Si[OCH₂CH(CH₃)(OCH₃)]₃

According to a particularly advantageous form, the organoalkoxysilane of formula (I) is tetraethoxysilane or tetramethoxysilane.

The dialkyltin salts of formula (II) are well known compounds described in particular in French patent FR-2 592 657 cited as reference.

Use may be made, for example, of the dialkyltin salts of formula:

(CH₃COO)₂Sn(CH₃)₂

(CH₃COO)₂Sn(n-butyl)₂

(CH₃COO)₂Sn(n-octyl)₂

[CH₃(CH₂)₈COO]₂Sn(CH₃)₂

[CH₃(CH₂)₃CH(C₂H₅)COO]₂Sn(CH₃)₂

(CH₃COO)₂Sn(CH₂C₆H₅)₂

[CH₃(CH₂)₃CH(C₂H₅)COO]₂Sn(CH₃)₂

[CH₃(CH₂)₃CH(C₂H₅)COO]₂Sn(n-butyl)₂

[CH₃(CH₂)₁₄COO]₂Sn(n-butyl)₂

[CH₃(CH₂)₇—CH═CH—(CH₂)₇COO]₂Sn(n-butyl)₂

[CH₃(CH₂)₁₂COO]₂Sn(C₂H₅)₂

[CH₃(CH₂)₁₀COO]₂Sn(n-butyl)₂

[CH₃(CH₂)₁₀COO]₂Sn(n-octyl)₂

According to a particularly advantageous embodiment, the dialkyltin salt of formula (II) is chosen from the group consisting of:
dibutyltin dilaurate, of formula:

[CH₃(CH₂)₃]₂Sn[OCO(CH₂)₁₀CH₃]₂; and
dibutyltin diacetate, of formula:

[CH₃(CH₂)₃]₂Sn[OCOCH₃]₂

According to another preferred embodiment:
the tin-silicon compound (D1) is:
   the product of the reaction between tetramethoxysilane and dibutyltin dilaurate, of formula:

[CH₃(CH₂)₃]₂Sn[OCO(CH₂)₁₀CH₃]₂; or
the product of the reaction between tetraethoxysilane and dibutyltin diacetate, of formula:

[CH₃(CH₂)₃]₂Sn[OCOCH₃)₂

Mention may be made, as concrete examples of compounds of aminated polyalkoxysilane type (D3), of those with the following formulae:

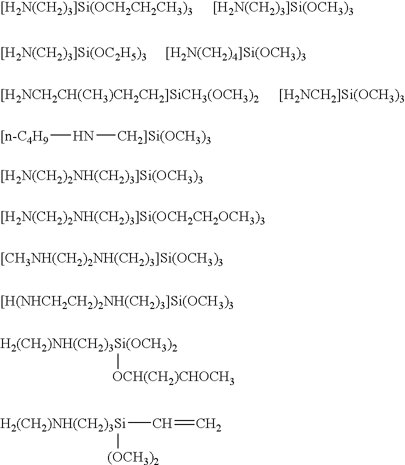

The preparation of the aminated polyalkoxysilane compounds (D3) appears more specifically in U.S. Pat. No. 2,754,311, U.S. Pat. No. 2,832,754, U.S. Pat. No. 2,930,809 and U.S. Pat. No. 2,971,864.

It is particularly advantageous to use, as catalytic system (D), the following combination:
a tin-silicon compound (D1) which is the product of the reaction between:
   tetramethoxysilane and dibutyltin dilaurate, of formula:

[CH₃(CH₂)₃]₂Sn[OCO(CH₂)₁₀CH₃]₂; or
tetraethoxysilane and dibutyltin diacetate, of formula:

[CH₃(CH₂)₃]₂Sn[OCOCH₃]₂
and an aminated polyalkoxysilane compound (D3) of formula:

H₂N(CH₂)₂NH(CH₂)₃Si(OCH₃)₃

### Description of the Silicone Base:

In the above or the below, unless otherwise mentioned, the percentages are by weight.

The catalytic system which has thus been described is used to make possible or facilitate the curing to give silicone elastomers, from room temperature, of polyorganosiloxane bases crosslinkable by polycondensation reactions which are provided in the two-component form, the catalytic system being incorporated in one of the fractions with a crosslinking agent (B) while the other fraction comprises a reactive polyorganosiloxane (A) and water.

According to one embodiment of the invention, the organopolysiloxane composition according to the invention comprises:
(a) a silicone base capable of curing to give a silicone elastomer in the presence of a catalyst by polycondensation reactions comprising:
   per 100 parts by weight of at least one α,ω-dihydroxydiorganopolysiloxane reactive polymer (A), the organic radicals of which are hydrocarbon radicals preferably chosen from the group consisting of: alkyls having from 1 to 20 carbon atoms; cycloalkyls having from 3 to 8 carbon atoms; alkenyls having from 2 to 8 carbon atoms and cycloalkenyls having from 5 to 8 carbon atoms;
   from 0.1 to 60 parts by weight of at least one crosslinking agent (B) chosen from the group consisting of: polyalkoxysilanes, products originating from the partial hydrolysis of a polyalkoxysilane, and polyalkoxysiloxanes;
   from 0 to 250 parts by weight, preferably from 5 to 200 parts by weight, of at least one filler (C);
   from 0.001 to 10 parts by weight of water,
   from 0 to 100 parts by weight of at least one nonreactive linear polyorganosiloxane polymer (E) consisting of a linear homopolymer or copolymer, the monovalent organic substituents of which per molecule, which are identical to or different from one another and which are bonded to the silicon atoms, are chosen from alkyl, cycloalkyl, alkenyl, aryl, alkylarylene and arylalkylene radicals,
   from 0 to 20 parts by weight of a coloring base or of a coloring agent (F),
   from 0 to 70 parts by weight polyorganosiloxane resins (G), and
   from 0 to 20 parts of auxiliary additives (H) known to a person skilled in the art, such as plasticizing agents, crosslinking retardants, mineral oils, antimicrobial agents or heat stabilizers, such as titanium, iron or cerium oxides, and
b) from 0.1 to 50 parts by weight of the polycondensation catalytic system (D).

The α,ω-dihydroxydiorganopolysiloxane reactive polymers (A) which can be used in the silicone bases according to the invention are more particularly those corresponding to the following formula (I):

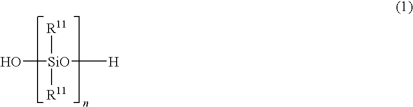

in which formula:
the R¹¹ substituents, which are identical or different, each represent a saturated or unsaturated, substituted or unsubstituted, aliphatic, cyclanic or aromatic, monovalent C₁ to C₁₃ hydrocarbon radical; and
n has a value sufficient to confer, on the polyorganosiloxanes of formula (1) a dynamic viscosity at 25° C. ranging from 10 to 1 000 000 mPa·s.

It should be understood that, in the context of the present invention, use may be made, as reactive polyorganosiloxane (A), of a mixture composed of several hydroxylated polyorganosiloxanes which differ from one another in the value of the viscosity and/or the nature of the substituents bonded to the silicon atoms. Furthermore, it should be indicated that the hydroxylated polyorganosiloxanes of formula (1) can optionally comprise T units of formula R¹²SiO_{3/2} and/or Q units of formula SiO_{4/2} in a proportion of at most 1% (these % values expressing the number T and/or Q units per 100 silicon atoms).

Use is made of linear hydroxylated diorganopolysiloxane reactive polymers (A) having a dynamic viscosity at 25° C. ranging from 10 to 1 000 000 mPa·s and preferably ranging from 50 to 200 000 mPa·s.

A large majority of these base polyorganosiloxanes are sold by manufacturers of silicones. Moreover, their manufacturing techniques are well known; they are described, for example, in French patents FR-A-1 134 005, FR-A-1 198 749 and FR-A-1 226 745.

The R¹¹ and R¹² substituents mentioned above for the reactive polyorganosiloxanes (A) can be chosen from the following radicals:
alkyl and haloalkyl radicals having from 1 to 13 carbon atoms, such as the methyl, ethyl, propyl, isopropyl, butyl, pentyl, hexyl, 2-ethylhexyl, octyl, decyl, 3,3,3-trifluoropropyl, 4,4,4-trifluorobutyl or 4,4,4,3,3-pentafluorobutyl radicals,
cycloalkyl and halocycloalkyl radicals having from 5 to 13 carbon atoms, such as the cyclopentyl, cyclohexyl, methylcyclohexyl, propylcyclohexyl, 2,3-difluorocyclobutyl or 3,4-difluoro-5-methylcycloheptyl radicals,
alkenyl radicals having from 2 to 8 carbon atoms, such as the vinyl, allyl or but-2-enyl radicals,
mononuclear aryl and haloaryl radicals having from 6 to 13 carbon atoms, such as the phenyl, tolyl, xylyl, chlorophenyl, dichlorophenyl or trichlorophenyl radicals, and
cyanoalkyl radicals, the alkyl sequences of which have from 2 to 3 carbon atoms, such as the β-cyanoethyl and γ-cyanopropyl radicals.

Mention may be made, as examples of R¹¹ and R¹² radicals, of alkyl radicals having from 1 to 8 carbon atoms, such as methyl, ethyl, propyl, butyl, hexyl and octyl, vinyl radicals or phenyl radicals.

Mention may be made, as examples of substituted R¹¹ and R¹² radicals, of the 3,3,3-trifluoropropyl, chlorophenyl and β-cyanoethyl radicals.

In the products of formula (1) generally used industrially, at least 60% by number of the R¹¹ and R¹² radicals are methyl radicals, the other radicals generally being phenyl and/or vinyl radicals.

Mention may be made, as crosslinking agent (B), of:
silanes of following general formula (2):

R¹³ₖSi(OR¹⁴)₍₄₋ₖ₎ (2)

in which the R¹⁴ symbols, which are identical or different, represent alkyl radicals having from 1 to 8 carbon atoms, such as the methyl, ethyl, propyl, butyl, pentyl or 2-ethylhexyl radicals, or C₃-C₆ oxyalkylene radicals, the R¹³ symbol represents a saturated or unsaturated, linear or branched, aliphatic hydrocarbon group, a saturated or unsaturated and/or aromatic, monocyclic or polycyclic, carbocyclic group, and k is equal to 0 or 1; and
the partial hydrolysis products of the silane of formula (2).

Mention may be made, as examples of C₃-C₆ alkoxyalkylene radicals, of the following radicals:

CH₃OCH₂CH₂—

CH₃OCH₂CH(CH₃)—

CH₃OCH(CH₃)CH₂—

C₂H₅OCH₂CH₂CH₂—

The R¹³ symbol represents a C₁-C₁₀ hydrocarbon radical encompassing:
C₁-C₁₀ alkyl radicals, such as methyl, ethyl, propyl, butyl, pentyl, 2-ethylhexyl, octyl or decyl radicals,
the vinyl or allyl radicals, and
C₅-C₈ cycloalkyl radicals, such as the phenyl, tolyl and xylyl radicals.

The crosslinking agents (B) of formula (2) are products accessible in the silicones market; furthermore, their use in compositions curing from room temperature is known; it occurs in particular in French patents FR-A-1 126 411, FR-A-1 179 969, FR-A-1 189 216, FR-A-1 198 749, FR-A-1 248 826, FR-A-1 314 649, FR-A-1 423 477, FR-A-1 432 799 and FR-A-2 067 636.

Preference is more particularly given, among the crosslinking agents (B), to alkyltrialkoxysilanes, alkyl silicates and alkyl polysilicates, in which the organic radicals are alkyl radicals having from 1 to 4 carbon atoms.

The alkyl silicates can be chosen from methyl silicate, ethyl silicate, isopropyl silicate, n-propyl silicate and the polysilicates chosen from the partial hydrolysis products of these silicates; these are polymers composed of a significant proportion of units of formula:

(R¹⁴O)₃SiO_{1/2}, R¹⁴OSiO_{3/2}, (R¹⁴O)₂SiO_{2/2} and SiO_{4/2};

the R¹⁴ symbol representing the methyl, ethyl, isopropyl and/or n-propyl radicals. The basis for their characterization is usually their silica content, which is established by assaying the hydrolysis product of a sample.

Mention is more particularly made, as other examples of crosslinking agents (B) which can be used, of the following silanes:

CH₃Si(OCH₃)₃; C₂H₅Si(OC₂H₅)₃; C₂H₅Si(OCH₃)₃

CH₂═CHSi(OCH₃)₃; CH₂═CHSi(OCH₂CH₂OCH₃)₃

C₆H₅Si(OCH₃)₃; [CH₃][OCH(CH₃)CH₂OCH₃]Si[OCH₃]₂

Si(OCH₃)₄; Si(OC₂H₅)₄; Si(OCH₂CH₂CH₃)₄; Si(OCH₂CH₂CH₂CH₃)₄

Si(OC₂H₄OCH₃)₄; CH₃Si(OC₂H₄OCH₃)₃; ClCH₂Si(OC₂H₅)₃;

Mention may be made, as other examples of crosslinking agent (B), of ethyl polysilicate or n-propyl silicate.

Use is generally made of 0.1 to 60 parts by weight of crosslinking agent of formula (2) per 100 parts by weight of reactive polymer of formula (1).

The compositions according to the invention can additionally comprise reinforcing or semireinforcing or bulking fillers (C) which are preferably chosen from siliceous fillers.

The reinforcing fillers are preferably chosen from pyrogenic silicas and precipitated silicas. They generally have a specific surface, measured according to the BET methods, of at least 50 m²/g, preferably of greater than 70 m²/g, a mean size of the primary particles of less than 0.1 μm (micrometer) and a bulk density of less than 200 g/liter.

These silicas can be incorporated as is or after having been treated with organosilicon compounds normally used for this use. These compounds include methylpolysiloxanes, such as hexamethyldisiloxane, octamethyltrisiloxane or octamethylcyclotetrasiloxane, methylpolysilazanes, such as hexamethyldisilazane or hexamethylcyclotrisilazane, chlorosilanes, such as dimethylchlorosilane, trimethylchlorosilane, methyl-vinyldichlorosilane or dimethylvinylchlorosilane, or alkoxysilanes, such as dimethyldimethoxysilane, dimethylvinylethoxysilane and trimethylmethoxysilane.

During this treatment, the silicas can increase their starting weight up to a level of 20%, preferably 18% approximately.

The semireinforcing or bulking fillers have a particle diameter of greater than 0.1 μm (micrometer) and are chosen from ground quartz, calcined clays and diatomaceous earths.

In addition to the main constituents (A), (B), (C) and (D), nonreactive linear polyorganosiloxane polymers (E) can be introduced with the intention of acting on the physical characteristics of the compositions in accordance with the invention and/or on the mechanical properties of the elastomers resulting from the curing of these compositions.

These nonreactive linear polyorganosiloxane polymers (E) are well known; they comprise more especially: α,ω-bis(triorganosiloxy)diorganopolysiloxane polymers with viscosities of at least 10 mPa·s at 25° C. formed essentially of diorganosiloxy units and of at least 1% of monoorganosiloxy and/or siloxy units, the organic radicals bonded to the silicon atoms being chosen from the methyl, vinyl and phenyl radicals, 60% at least of these organic radicals being methyl radicals and 10% at most being vinyl radicals. The viscosity of these polymers can reach several tens of millions of mPa·s at 25° C.; they thus comprise oils with a fluid to viscous appearance and soft to hard gums. They are prepared according to the usual techniques described more specifically in French patents FR-A-978 058, FR-A-1 025 150, FR-A-1 108 764 and FR-A-1 370 884. Use is preferably made of α,ω-bis(trimethylsiloxy)dimethylpolysiloxane oils with a viscosity ranging from 10 mPa·s to 1000 mPa·s at 25° C. These polymers, which act as plasticizers, can be introduced in a proportion of at most 70 parts, preferably of 5 to 20 parts, per 100 parts of the α,ω-dihydroxydiorganopolysiloxane reactive polymers (A).

The compositions according to the invention can in addition advantageously comprise at least one silicone resin (G). These silicone resins are branched organopolysiloxane polymers which are well known and which are available commercially. They exhibit, per molecule, at least two different units chosen from those of formula R′″₃SiO_{1/2} (M unit), R′″₂SiO_{2/2} (D unit), R′″SiO_{3/2} (T unit) and SiO_{4/2} (Q unit). The R″′ radicals are identical or different and are chosen from linear or branched alkyl radicals or the vinyl, phenyl or 3,3,3-trifluoropropyl radicals. Preferably, the alkyl radicals exhibit from 1 to 6 carbon atoms inclusive. More particularly, mention may be made, as alkyl R radicals, of the methyl, ethyl, isopropyl, tert-butyl and n-hexyl radicals. These resins are preferably hydroxylated and have, in this case, a content by weight of hydroxyl group of between 5 and 500 meq/100 g.

Mention may be made, as examples of resins, of MQ resins, MDQ resins, TD resins and MDT resins.

The crosslinking to give an elastomer of the polyorganosiloxane bases (by a polycondensation reaction) which has just been described is carried out under the effect of the catalytic system (D) defined above. These compositions crosslink at room temperature in the presence of water present in the composition.

For use of the silicone compositions according to the invention, each composition is produced in the form of a two-component system formed of two parts P1 and P2 intended to be brought into contact with one another in order to produce the crosslinked elastomer by polycondensation.

According to another of its aspects, the present invention relates to a two-component system which is a precursor of the organopolysiloxane composition according to the invention, characterized:
in that it is provided in two separate parts P1 and P2 intended to be mixed in order to form said composition, and
in that one of these parts comprises the catalytic system (D) as defined above and the crosslinking agent or agents (B) whereas the other part is devoid of the abovementioned entities and comprises:
   100 parts by weight of the α,ω-dihydroxydiorganopolysiloxane reactive polymer(s) (A), and
   from 0.001 to 10 part(s) by weight of water.

According to a preferred embodiment, the two-component system which is precursor of the organopolysiloxane composition according to the invention is characterized in that:
the part P1 comprises:
   100 parts by weight of at least one α,ω-dihydroxydiorganopolysiloxane reactive polymer (A), the organic radicals of which are hydrocarbon radicals preferably chosen from the group consisting of: alkyls having from 1 to 20 carbon atoms; cycloalkyls having from 3 to 8 carbon atoms; alkenyls having from 2 to 8 carbon atoms and cycloalkenyls having from 5 to 8 carbon atoms;
   from 0.001 to 10 parts by weight of water,
   from 0 to 250 parts by weight, preferably from 5 to 200 parts by weight, of at least one filler (C);
   from 0 to 100 parts by weight of at least one nonreactive linear polyorganosiloxane polymer (E) consisting of a linear homopolymer or copolymer, the monovalent organic substituents of which per molecule, which are identical to or different from one another and which are bonded to the silicon atoms, are chosen from alkyl, cycloalkyl, alkenyl, aryl, alkylarylene and arylalkylene radicals,
   from 0 to 70 parts by weight of polyorganosiloxane resins (G), and
   from 0 to 20 parts by weight of a coloring base or of a coloring agent (F); and
the part P2 comprises:
   from 0.1 to 60 parts by weight of at least one crosslinking agent (B) chosen from the group consisting of: polyalkoxysilanes, products originating from the partial hydrolysis of a polyalkoxysilane, and polyalkoxysiloxanes;
   from 0.1 to 50 parts by weight of the polycondensation catalytic system (D) as defined in any one of claims 1 and 3 to 8;
   from 0 to 20 parts by weight of a coloring base or of a coloring agent (F),
   from 0 to 70 parts by weight of at least one nonreactive linear polyorganosiloxane polymer (E) consisting of a linear homopolymer or copolymer, the monovalent organic substituents of which per molecule, which are identical to or different from one another and which are bonded to the silicon atoms, are chosen from alkyl, cycloalkyl, alkenyl, aryl, alkylarylene and arylalkylene radicals, and
   from 0 to 125 parts by weight, preferably from 0.1 to 40 parts by weight, of at least one filler (C).

The two-component compositions according to the invention can be shaped, extruded or in particular molded according to varied shapes and then be cured at room temperature to give an elastomer.

The compositions in accordance with the invention can be employed for multiple applications, such as the formation of seals and/or adhesive bonding in the construction industry or the transportation industry (examples: motor vehicle, aerospatial, railroad, maritime and aeronautical), the assembling of the most diverse materials (metals, plastics, natural and synthetic rubbers, wood, boards, polycarbonate, earthenware, brick, ceramic, glass, stone, concrete and masonry components), the insulation of electrical conductors, the coating of electronic circuits and the preparation of molds used in the manufacture of items made of synthetic resins or foams.

In addition, they are suitable for the formation of “in situ” seals used in the motor vehicle industry. These “in situ” seals encompass several types, namely “flattened” seals (known as “flowed gasket” seals), “shaped” seals (known as “profiled” seals) and “injection-molded” seals.

The “flattened” seals are formed following the application of a pasty strip of the compositions to the region of contact between 2 metal or plastic components to be assembled. The pasty strip is first deposited on one of the components and then the other component is immediately applied to the first; this results in flattening of the strip before it is converted into elastomer. Seals of this type are aimed at assemblages which do not have to be taken apart in common practice (oil sump seals, timing case seals, and the like).

The “shaped” seals are also obtained following the application of a pasty strip of the compositions to the region of contact between 2 components to be assembled. However, after the deposition of the pasty strip on one of the components, the strip is given time to completely cure to give an elastomer and only at this moment is the second component applied to the first.

Furthermore, the seals, due to their rubbery or fluid natures, match all the unevennesses of the surfaces to have seals formed on them; for this reason, it is pointless:

(1) to carefully machine the metal surfaces which have to be brought into contact with one another, and
(2) to forcibly tighten the assemblages obtained; these distinguishing features make it possible, to a certain extent, to dispense with fastening seals, spacers or ribs usually intended to stiffen and reinforce the components of the assemblages.

As the compositions in accordance with the invention rapidly cure at room temperature and even in an enclosed environment, the result of this is that the “shaped” seals (and also the other “in situ” seals) resulting from the curing of these compositions are self-adhesive and can be manufactured under highly constricting industrial manufacturing conditions. For example, they can be manufactured on the normal assembly lines of the motor vehicle industry equipped with an automatic device for the deposition of the compositions. This automatic device very often has a mixing head and a depositing nozzle, the latter moving along according to the outline of the seals to be manufactured.

The compositions manufactured and distributed by means of this device have to have a curing time which is properly adjusted in order, on the one hand, to avoid the compositions from setting solid in the mixing head and, on the other hand, to obtain complete crosslinking after the end of the deposition of the pasty strip on the components on which seals are to be formed. These “shaped” seals are more especially suitable for cylinder head cover seals, gearbox case cover seals, timing spacer seals and even oil sump seals.

The injection-molded seals are formed in an enclosed environment, in cavities which are often completely closed; the compositions placed in these cavities are rapidly converted to elastomers. These seals can, for example, ensure the leaktightness of crankshaft bearings.

The compositions in accordance with the invention are also suitable for the formation of rapidly curing and self-adhesive seals and/or adhesives in other fields than the motor vehicle industry. Thus, they can be used to adhesively bond and to form seals with regard to plastic switch cabinets, to produce seals and/or adhesives:
for domestic electrical appliances, in particular for assembling components such as the glass and metal walls of ovens, vacuum cleaner and iron components,
for electronic housings, for example used in the motor vehicle industry (examples: brake power distributor, and the like),
for the assembling, adhesive bonding, forming a seal on a tank, for example in the motor vehicle industry.

The compositions in accordance with the invention are very particularly suitable for the formation of seals in an enclosed environment liable to be subjected to a heat treatment because of the type of application, for example for seals used to adhesively bond the components in domestic electrical appliances, such as baking ovens. This is because, in some applications, the seal has to withstand temperatures of greater than or equal to 100° C. while maintaining an adhesion in accordance with the requirements of the application.

Another subject matter of the invention relates to the use of a composition according to the invention or of a two-component system according to the invention in the manufacture of self-adhesive seals and/or of adhesives, in particular in the motor vehicle industry or in the field of domestic electrical appliances.

The final subject matter of the invention relates to a self-adhesive seal and/or an adhesive prepared by room temperature curing:
of an organopolysiloxane composition as defined according to the invention, or
of an organopolysiloxane composition resulting from the mixing of the parts P1 and P2 of the two-component composition as defined according to the invention.

The invention also relates to the use of a composition according to the invention or of a two-component system according to the invention in the manufacture of self-adhesive seals and/or of adhesives, in particular in the motor vehicle industry or in the field of domestic electrical appliances.

The self-adhesive seal and/or the adhesive retain good adhesion after a heat treatment.

According to a specific form of the invention, the self-adhesive seal and/or the adhesive retain good adhesion after a heat treatment ≧100° C. for 3 days, that is to say:
a breaking stress ≧1.2 MPa and
a cohesive failure facies ≧70%.

According to a specific form of the invention, the self-adhesive seal and/or the adhesive retain good mechanical properties after a heat treatment; in particular, after a heat treatment ≧100° C. for 3 days, the mechanical properties are as follows:
the Shore A hardness after heat treatment ≧0.7× Shore A hardness before heat treatment, and
the tensile strength after heat treatment ≧0.7× tensile strength before heat treatment.

The invention also relates to the use of a composition according to the invention or of a two-component system according to the invention in the manufacture of self-adhesive seals and/or of adhesives exhibiting properties of resistance to power unit fluids of use in particular in the motor vehicle industry.

According to a specific form of the invention, the self-adhesive seal and/or the adhesive according to the invention retain good mechanical properties after aging at 150° C. in a 0w30 oil for 3 days:
Shore A hardness after aging ≧0.6× Shore A hardness before heat treatment,
tensile strength after heat treatment ≧0.6× tensile strength before heat treatment.

Other advantages and characteristics of the present invention will become apparent on reading the following examples, given by way of illustration and without implied limitation.

### EXAMPLE

### Preparation of a Silicone Composition which Crosslinks at Room Temperature by a Polycondensation Reaction

A two-component composition comprising the following parts P1 and P2 is prepared:

### 1) Part P1:

a: pyrogenic silica having a BET specific surface of 200 m²/g,
b: polydimethylsiloxane oil blocked at each of the chain ends by a (CH₃)₃SiO_{0.5} unit, having a viscosity of 100 mPa·s at 25° C.,
c: hydroxylated polydimethylsiloxane oil blocked at each of the chain ends by a (CH₃)₂(OH)SiO_{0.5} unit, having a viscosity of 3500 mPa·s at 25° C.,
d: ground quartz exhibiting a mean particle diameter of 10 μm,
e: water, and
f: hydroxylated polydimethylsiloxane oil blocked at each of the chain ends by a (CH₃)₂(OH)SiO_{0.5} unit, having a viscosity of 50 mPa·s at 25° C.,

### 2) Part P2:

D1: h1 or h2, with:
h1: tin-silicon compound which is the reaction product of Si(OCH₃)₄ and of dibutyltin dilaurate (DBTDL) of formula [CH₃ (CH₂)₁₀COO]₂Sn(n-butyl)₂ (reaction temperature=100° C.)
h2: tin-silicon compound which is the reaction product of Si(OC₂H₅)₄ and of dibutyltin diacetate (DBTDA) of formula [CH₃(CH₂)₃]₃Sn[OCOCH₃]₂ (reaction temperature=130° C.)
i: organoaminosilane compound (D3) of formula: H₂N(CH₂)₂NH(CH₂)₃Si(OCH₃)₃;
j: ethyl polysilicate (SiOC₂H₅)₄;
l: polymethylphenylsiloxane oil blocked at each of the chain ends by a (CH₃)₃SiO_{0.5} unit, having a viscosity of 125 mPa·s at 25° C.;
abovementioned ingredient a; and
abovementioned ingredient d.

The compositions are given in table 1 below.

TABLE 1

| | COMPOSITIONS: PARTS BY WEIGHT | | | |
|---|---|---|---|---|
| | | Example | Example | Example |
| | Ingredients | 1 | 2 | 3 |
| Part | a | 6.6 | 6.6 | 6.5 |
| P1 | b | 3.0 | 3.0 | 0 |
| | c | 51.0 | 51.0 | 50.0 |
| | d | 42.3 | 42.3 | 41.5 |
| | e | 0.075 | 0.075 | 0.074 |
| | f | 1.8 | 1.8 | 2.0 |
| Part | h1 | 1.21 | 0 | 0 |
| P2 | h2 | 0 | 1.21 | 5.9 |
| | i | 2.33 | 2.33 | 21.4 |
| | j | 1.25 | 1.25 | 8.3 |
| | k | 4.42 | 4.42 | 18.8 |
| | a | 0.5 | 0.5 | 8.0 |
| | d | 2.0 | 2.0 | 0 |
| | l | 0.0 | 0.0 | 37.6 |

### 3) Processing:

10 parts by volume of the component P2 are added to 100 parts by volume of the component P1. Self-adhesive seals are obtained which, even after a heat treatment at 220° C. for 3 days, exhibit a noteworthy adhesion to a glass/stainless steel support, as is shown by the results in table 2.

In order to evaluate the adhesive properties of the compositions (after mixing the two components P1 and P2) before and after a heat treatment at 220° C. for 3 days, mixed adhesive bondings (standard MNRPS-748, seal with a thickness of 1 mm) were carried out between glass/stainless steel.

TABLE 2

| | | Example | Example | Example |
|---|---|---|---|---|
| | | 1 | 2 | 3 |
| Pot life (min) | | 1 to 2 | 1 to 2 | 1 to 2 |
| Assemblage which can be handled | | Yes | Yes | Yes |
| in at most 10 minutes | | | | |
| Properties | Adhesive test | 2.0 | 1.9 | 2.0 |
| before heat | Breaking stress | | | |
| treatment | (MPa) | | | |
| (after 5 days | Type of failure | 100 | 100 | 100 |
| at 23° C.) | (% of cohesion) | | | |
| Properties | Adhesive test | 1.75 | 1.75 | 2.0 |
| after heat | Breaking stress | | | |
| treatment | (MPa) | | | |
| (3 days at | Type of failure | 100 | 100 | 100 |
| 220° C.) | (% of cohesion) | | | |
| Properties | Adhesive test | Not | Not | 1.8 |
| after heat | Breaking stress | measured | measured | |
| treatment | (MPa) | | | |
| (3 days at | Type of failure | Not | Not | 100 |
| 250° C.) | (% of cohesion) | measured | mesured | |

Breaking stress: measurements carried out according to the instructions of standard MNRPS-748,
Cohesion: measurements carried out according to the instructions of standard MNRPS-748.

### For Example 3:

10 parts by volume of the component P2 are added to 100 parts by volume of the component P1. Self-adhesive seals are obtained which, even after a maximum heat treatment (3 days at 220° C. or at 250° C. or at 300° C.) or a continuous heat treatment (1000 h at 250° C.), exhibit outstanding mechanical properties, as is shown by the results in table 3.

In order to evaluate the mechanical properties of the compositions (after mixing the two components P1 and P2) before and after a heat treatment, measurements of Shore A hardness (SAH) were carried out according to the instructions of standard ASTM-D2240 and measurements of elongation at break (E/B, %) and of tensile strength (T/S, MPa) were carried out according to the instructions of standard ASTM-D412. The results are recorded in table 3.

TABLE 3

| | |
|---|---|
| Mechanical properties | Example 3 |

| | | | |
|---|---|---|---|
| At the start | Mechanical properties | SAH | 51 |
| | after 5 days at 23° C. | E/B | 135 |
| | | T/S | 3.62 |
| Maximum heat | Mechanical properties | SAH | 44 |
| ageing | after 5 days at 23° C. + | E/B | 161 |
| | 3 days at 220° C | T/S | 3.61 |
| | Mechanical properties | SAH | 48 |
| | after 5 days at 23° C. + | E/B | 136 |
| | 3 days at 250° C. | T/S | 3.75 |
| | Mechanical properties | SAH | 67 |
| | after 5 days at 23° C. + | E/B | 75 |
| | 3 days at 300° C. | T/S | 4.97 |
| Continuous | Mechanical properties | SAH | 79 |
| heat ageing | after 5 days at 23° C. + | E/B | 77 |
| | 1000 h at 250° C. | T/S | 6.30 |

1. A method for preparing a self adhesive seal and/or an adhesive comprising using an organopolysiloxane composition vulcanizable to give a silicone elastomer from room temperature by a polycondensation reaction to form said self-adhesive seal and/or adhesive which retain adhesion after a heat treatment at a temperature ≧100° C. for 3 days and exhibit:
a breaking stress ≧1.2 MPa and
a cohesive failure facies ≧70%,
said organopolysiloxane composition comprising:
a silicone base capable of curing to give a silicone elastomer in the presence of a catalyst by a polycondensation reaction, said silicone base comprising:
per 100 parts by weight of at least one reactive α,ω-dihydroxydiorganopolysiloxane polymer (A),
from 0.1 to 60 parts by weight of at least one crosslinking agent (B), and
from 0.001 to 10 parts by weight of water, and
b) a catalytically effective amount of a polycondensation catalytic system (D), wherein the catalytic system (D) comprises a mixture of a tin-silicon compound (D1) and at least one aminated polyalkoxysilane compound (D3), said compounds corresponding to the following definitions:
the tin-silicon compound (D1) is the product a reaction of at least one organoalkoxysilane corresponding to the following formula (I):
R⁰ₐSi(OR¹)₄₋ₐ (I)
with at least one dialkyltin salt corresponding to the following formula (II):
R²R³Sn(OCOR⁴)₂ (II)
in which formulae:
the R⁰ substituents represent: a saturated or unsaturated, linear or branched, aliphatic hydrocarbon group, a saturated or unsaturated and/or aromatic, monocyclic or polycyclic, carbocyclic group,
the R¹ substituents, which are identical or different, represent a saturated or unsaturated aliphatic hydrocarbon group; R¹ can additionally mean an ROR′¹ radical in which R is a divalent hydrocarbon radical having up to 6 carbon atoms and R′¹ represents a saturated or unsaturated aliphatic hydrocarbon group;
a=0, 1, 2 or 3;
the R², R³ and R⁴ substituents represent, each independently of one another, a saturated or unsaturated, linear or branched, aliphatic hydrocarbon group, a saturated or unsaturated and/or aromatic, monocyclic or polycyclic, carbocyclic group; and
the aminated polyalkoxysilane compound (D3) is of formula III:
(R⁵)_{b}(R⁶)_{c}Si(OR⁷)_{4-(b+c)} (III)
in which formula:
b=0 or 1;
c=1;
R⁵ represents a saturated or unsaturated, linear or branched, aliphatic hydrocarbon group, a saturated or unsaturated and/or aromatic, monocyclic or polycyclic, carbocyclic group,
R⁷ each represent, independently of one another, a saturated or unsaturated aliphatic hydrocarbon group;
R⁶ represents a functional group of formula:
—Z—(X)ₙ
with:
n=1 or 2;
Z represents a divalent radical derived from a group selected from: a saturated or unsaturated aliphatic hydrocarbon group, a saturated, unsaturated and/or aromatic, monocyclic or polycyclic, carbocyclic group; said divalent radical optionally being substituted or interrupted by at least one oxygen atom and/or at least one nitrogen atom;
X represents:
an —NR⁸R⁹ residue where the R⁸ and R⁹ substituents, which are identical or different, each represent a hydrogen atom, a saturated or unsaturated, linear or branched, aliphatic hydrocarbon group, optionally substituted by an amino group, a saturated or unsaturated and/or aromatic, monocyclic or polycyclic, carbocyclic group, it being possible for the R⁸ and R⁹ substituents optionally in addition to form, together and with the nitrogen atom to which they are bonded, a ring comprising, in the ring, 3 to 6 carbon atoms and one or two nitrogen atom(s); or
an —R¹⁰—NH₂ radical where the R¹⁰ symbol represents a divalent radical derived from a group selected from: a saturated or unsaturated aliphatic hydrocarbon group, a saturated, unsaturated and/or aromatic, monocyclic or polycyclic, carbocyclic group and a group exhibiting a saturated or unsaturated aliphatic hydrocarbon part and a saturated, unsaturated and/or aromatic, monocyclic or polycyclic, carbocyclic part; said divalent radical optionally being substituted or interrupted by at least one oxygen atom and/or at least one nitrogen atom;
it being possible for said aminated polyalkoxysilane (D3) optionally to be provided in the form of a hydrolysis condensation product derived from the formula (III).

2. The use A method as claimed in claim 1, wherein characterized in that:
(a) the silicone base capable of curing to give a silicone elastomer in the presence of a catalyst by polycondensation reactions comprises:
per 100 parts by weight of at least one α,ω-dihydroxydiorganopolysiloxane reactive polymer (A), the organic radicals of which are hydrocarbon radicals;
from 0.1 to 60 parts by weight of at least one crosslinking agent (B) selected from the group consisting of polyalkoxysilanes, products originating from the partial hydrolysis of a polyalkoxysilane, and polyalkoxysiloxanes;
from 0 to 250 parts by weight of at least one filler (C);
from 0.001 to 10 parts by weight of water,
from 0 to 100 parts by weight of at least one nonreactive linear polyorganosiloxane polymer (E) comprising a linear homopolymer or copolymer, the monovalent organic substituents of which per molecule, which are identical to or different from one another and which are bonded to the silicon atoms, are selected from the group consisting of alkyl, cycloalkyl, alkenyl, aryl, alkylarylene and arylalkylene radicals,
from 0 to 20 parts by weight of a coloring base or of a coloring agent (F),
from 0 to 70 parts by weight of a polyorganosiloxane resins (G), and
from 0 to 20 parts of an auxiliary additives (H) selected from the group consisting of plasticizing agents, crosslinking retardants, mineral oils, antimicrobial agents and heat stabilizers, and
(b) from 0.1 to 50 parts by weight of the polycondensation catalytic system (D).

3. A method as claimed in claim 1, wherein that the tin-silicon compound (D1) is prepared according to the following stages:
a) said at least one organoalkoxysilane (I) is reacted at a temperature ≧80° C., with said at least one dialkyltin salt (II) and
b) resulting product is isolated.

4. A method as claimed in claim 1, wherein substituents of the organoalkoxysilane of formula (I) and of the dialkyltin salt of formula (II) are defined in the following way:
R⁰ represents a linear or branched C₁-C₈ alkyl radical, a C₅-C₁₀ cycloalkyl radical or a C₆-C₁₈ aryl radical;
R¹ represents a linear or branched C₁-C₈ alkyl radical;
R² and R³, which are identical or different, each represent a linear or branched C₁-C₈ alkyl radical, a C₅-C₁₀ cycloalkyl radical or a C₆-C₁₈ aryl radical; and
R⁴ represents a linear or branched C₁-C₃₀ alkyl radical.

5. A method as claimed in claim 1, wherein the organoalkoxysilane of formula (I) is tetraethoxysilane or tetramethoxysilane.

6. A method as claimed in claim 1, wherein the dialkyltin salt of formula (II) is selected from the group consisting of:
dibutyltin dilaurate, of formula:
[CH₃(CH₂)₃]₂Sn[OCO(CH₂)₁₀CH₃]₂; and
dibutyltin diacetate, of formula:
[CH₃(CH₂)₃]₂Sn[OCOCH₃]₂

7. A method as claimed in claim 1, wherein:
the tin-silicon compound (D1) is the product of a reaction between tetramethoxysilane and dibutyltin dilaurate, of formula:
[CH₃(CH₂)₃]₂Sn[OCO(CH₂)₁₀CH₃]₂; or
the product of a reaction between tetraethoxysilane and dibutyltin diacetate, of formula:
[CH₃(CH₂)₃]₂Sn[OCOCH₃]₂.

8. A method as claimed in claim 1, wherein:
the tin-silicon compound (D1) is:
a product of a reaction between tetramethoxysilane and dibutyltin dilaurate, of formula:
[CH₃(CH₂)₃]₂Sn[OCO(CH₂)₁₀CH₃]₂; or
a product of a reaction between tetraethoxysilane and dibutyltin diacetate, of formula:
[CH₃(CH₂)₃]₂Sn[OCOCH₃)₂
and the aminated polyalkoxysilane compound (D3) has the formula:
H₂N(CH₂)₂NH(CH₂)₃Si(OCH₃)₃.

9. A two-component system which is a precursor of an organopolysiloxane composition vulcanizable to give a silicone elastomer from room temperature by a polycondensation reactions in the method of preparing a self-adhesive seal and/or adhesive
according to claim 2,
wherein said two component system is provided in two separate parts P1 and P2 intended to be mixed in order to form said composition, and
wherein one of said parts P1 or P2 comprises the catalytic system (D) and the crosslinking agent or agents (B) whereas the other part is devoid thereof, and said other part comprises:
100 parts by weight of the said α,ω-dihydroxydiorganopolysiloxane reactive polymer(s) (A), and
from 0.001 to 10 part(s) by weight of water.

10. A two-component system as claimed in claim 9, wherein:
part P1 comprises:
100 parts by weight of at least one α,ω-dihydroxydiorganopolysiloxane reactive polymer (A), the organic radicals of which are hydrocarbon radicals;
from 0.001 to 10 parts by weight of water,
from 0 to 250 parts by weight, of at least one filler (C);
from 0 to 100 parts by weight of at least one nonreactive linear polyorganosiloxane polymer (E) comprising a linear homopolymer or copolymer, the monovalent organic substituents of which per molecule, which are identical to or different from one another and which are bonded to the silicon atoms, are selected from the group consisting of alkyl, cycloalkyl, alkenyl, aryl, alkylarylene and arylalkylene radicals,
from 0 to 70 parts by weight of a polyorganosiloxane resin (G), and
from 0 to 20 parts by weight of a coloring base or of a coloring agent (F); and
the part P2 comprises:
from 0.1 to 60 parts by weight of at least one crosslinking agent (B) selected from the group consisting of polyalkoxysilanes, products originating from the partial hydrolysis of a polyalkoxysilane, and polyalkoxysiloxanes;
from 0.1 to 50 parts by weight of the polycondensation catalytic system (D);
from 0 to 20 parts by weight of a coloring base or of a coloring agent (F),
from 0 to 70 parts by weight of at least one nonreactive linear polyorganosiloxane polymer (E) comprising a linear homopolymer or copolymer, the monovalent organic substituents of which per molecule, which are identical to or different from one another and which are bonded to the silicon atoms, are selected from the group consisting of alkyl, cycloalkyl, alkenyl, aryl, alkylarylene and arylalkylene radicals, and
from 0 to 125 parts by weight, of at least one filler (C).

11. A method of claim 1 for the manufacture of an self-adhesive seal and/or of an adhesive adapted for use in the motor vehicle industry or in the field of domestic electrical appliances.

12. A method as claimed in claim 11, wherein the self-adhesive seal and/or the adhesive retains mechanical properties after a heat treatment at a temperature ≧100° C. for 3 days and exhibit:
a Shore A hardness after heat treatment ≧0.7× a Shore A hardness before heat treatment,
a tensile strength after heat treatment ≧0.7× a tensile strength before heat treatment.

13. A method as claimed in claim 11, adapted for manufacture of a self-adhesive seal and/or of adhesive exhibiting properties of resistance to power unit fluids for use in the motor vehicle industry.

14. A method as claimed in claim 13, wherein the self-adhesive seal and/or the adhesive retains mechanical properties after aging at 150° C. in a 0w30 oil for 3 days and exhibit:
a Shore A hardness after aging 0.6× a Shore A hardness before heat treatment,
a tensile strength after heat treatment ≧0.6× a tensile strength before heat treatment.

15. A self-adhesive seal and/or adhesive prepared by curing, at ambient temperature:
an organopolysiloxane composition comprising:
a) a silicone base capable of curing to give a silicone elastomer in the presence of a catalyst by a polycondensation reaction, said silicone base comprising:
per 100 parts by weight of at least one reactive α,ω-dihydroxydiorganopolysiloxane polymer (A),
from 0.1 to 60 parts by weight of at least one crosslinking agent (B), and
from 0.001 to 10 parts by weight of water, and b) a catalytically effective amount of a polycondensation catalytic system (D),
wherein the catalytic system (D) comprises a mixture of a tin-silicon compound (D1) and at least one aminated polyalkoxysilane compound (D3), said compounds corresponding to the following definitions:
the tin-silicon compound (D1) is the product of the reaction of at least one organoalkoxysilane corresponding to the following formula (I):
R⁰ₐSi(OR¹)₄₋ₐ (I)
with at least one dialkyltin salt corresponding to the following formula (II):
R²R³Sn(OCOR⁴)₂ (II)
in which formulae:
the R⁰ substituents represent: a saturated or unsaturated, linear or branched, aliphatic hydrocarbon group, a saturated or unsaturated and/or aromatic, monocyclic or polycyclic, carbocyclic group,
the R¹ substituents, which are identical or different, represent a saturated or unsaturated aliphatic hydrocarbon group; R¹ can additionally mean an ROR′¹ radical in which R is a divalent hydrocarbon radical having up to 6 carbon atoms and R′¹ represents a saturated or unsaturated aliphatic hydrocarbon group;
a=0, 1, 2 or 3;
the R², R³ and R⁴ substituents represent, each independently of one another, a saturated or unsaturated, linear or branched, aliphatic hydrocarbon group, a saturated or unsaturated and/or aromatic, monocyclic or polycyclic, carbocyclic group; and
the aminated polyalkoxysilane compound (D3) is of formula III:
(R⁵)_{b}(R⁶)_{c}Si(OR⁷)_{4-(b+c)} (III)
in which formula:
b=0 or 1;
c=1;
R⁵ represents a saturated or unsaturated, linear or branched, aliphatic hydrocarbon group, a saturated or unsaturated and/or aromatic, monocyclic or polycyclic, carbocyclic group,
R⁷ each represent, independently of one another, a saturated or unsaturated aliphatic hydrocarbon group;
R⁶ represents a functional group of formula:
—Z—(X)ₙ
with:
n=1 or 2;
Z represents a divalent radical derived from a group selected from: a saturated or unsaturated aliphatic hydrocarbon group, a saturated, unsaturated and/or aromatic, monocyclic or polycyclic, carbocyclic group; said divalent radical optionally being substituted or interrupted by at least one oxygen atom and/or at least one nitrogen atom:
X represents:
an NR⁸R⁹ residue where the R⁸ and R⁹ substituents, which are identical or different, each represent a hydrogen atom, a saturated or unsaturated, linear or branched, aliphatic hydrocarbon group, optionally substituted by an amino group, a saturated or unsaturated and/or aromatic, monocyclic or polycyclic, carbocyclic group, it being possible for the R⁸ and R⁹ substituents optionally in addition to form, together and with the nitrogen atom to which they are bonded, a ring comprising, in the ring, 3 to 6 carbon atoms and one or two nitrogen atom(s); or
an —R¹⁰—NH₂ radical where the R¹⁰ symbol represents a divalent radical derived from a group selected from: a saturated or unsaturated aliphatic hydrocarbon group, a saturated, unsaturated and/or aromatic, monocyclic or polycyclic, carbocyclic group and a group exhibiting a saturated or unsaturated aliphatic hydrocarbon part and a saturated, unsaturated and/or aromatic, monocyclic or polycyclic, carbocyclic part; said divalent radical optionally being substituted or interrupted by at least one oxygen atom and/or at least one nitrogen atom;
it being possible for said aminated polyalkoxysilane (D3) optionally to be provided in the form of a hydrolysis condensation product derived from the formula (III).
or
an organopolysiloxane composition resulting from mixing parts P1 and P2 of the two-component composition according to claim 9.
